(19) United States
(12) Patent Application Publication
(10) Pub. No.: US 2018/0347192 A1
(43) Pub. Date: Dec. 6, 2018

(54) BARRIER SHEET WITH COATED MESH PROVIDING SKID RESISTANCE AND VAPOR PERMEABILITY

(71) Applicant: Omnova Solutions Inc., Beachwood, OH (US)

(72) Inventors: William G. Hartman, North Royalton, OH (US); William R. Guillot, Monroe, NC (US); Milton L. Johnson, Pageland, SC (US)

(21) Appl. No.: 15/775,605

(22) PCT Filed: Nov. 10, 2016
(86) PCT No.: PCT/US16/61385

§ 371 Date: May 11, 2018

Related U.S. Application Data
(60) Provisional application No. 62/254,367, filed on Nov. 12, 2015.

(51) Int. Cl. E04C 2/24; B32B 5/02; B32B 21/10; B32B 21/08

(52) U.S. Cl. CPC E04C 2/24; B32B 5/022; B32B 5/024; B32B 21/10; B32B 2307/7265; B32B 2250/03; B32B 2255/02; B32B 2255/26; B32B 2307/724; B32B 21/08

(57) ABSTRACT

The present invention provides coated barrier sheets with improved skid resistant properties. Preferred embodiments are liquid water impermeable and water vapor permeable. The coated barrier sheets comprise a barrier sheet and a skid-resistant, coated mesh provide on at least a portion of a surface of the barrier sheet. As one utility, the barrier sheets may be incorporated into engineered wood panels.

### PRIORITY

The present patent application claims the benefit of U.S. Provisional Application having Ser. No. 62/254,367, filed on Nov. 12, 2015, entitled “ENGINEERED WOOD PANEL WITH COATED MESH”, which provisional Application is incorporated herein by reference in its entirety.

### FIELD OF THE INVENTION

The present invention is in the field of engineered wood panels including a barrier sheet on an engineered wood substrate (e.g., plywood, particleboard, MDF, strandboard, or the like). A coated mesh structure is applied onto the barrier sheet to help improve skid resistance while still allowing the panel to release moisture.

### BACKGROUND OF THE INVENTION

An engineered wood panel generally refers to a generally flat body comprising one or more wood composite materials. A wood composite material is a material comprising a plurality of wood or cellulosic pieces held together in a solid body by at least one binder matrix. The wood pieces may be incorporated into the composite in one or more forms. Exemplary forms of wood pieces include veneer sheets, flakes, powder, strands, wafers, combinations of these, and the like. The body of an engineered wood panel generally includes two, opposed major faces, side edges, and end edges. In many embodiments, the thickness of an engineered wood sheet can range from a fraction of a centimeter to many centimeters. In many instances, commercially available panels are available in thickness from 1 mm to about 50 mm. Often, if a structure having a thickness over 50 mm is desired, these would be formed by laminating a stack of thinner panels.

Many different kinds of engineered wood panels are known. Examples include oriented strand board (“OSB”), waferboard, particle board, chipboard, medium-density fiberboard, high density fiberboard, laminated veneer lumber, engineered flooring, plywood, boards that are a composite of strands and ply veneers, and the like. Example of wood composite materials are further described in the Supplement Volume to the Kirk-Othmer Encyclopedia of Chemical Technology, pp 765-810, 6th Edition and in U.S. Pat. Pub. No. 2014/0120301. Engineered wood panels are used in a variety of ways such as in residential, commercial or industrial building construction. Engineered panels are also used to make furniture and toys.

Engineered wood panels have been developed in which a barrier sheet is applied to one or both major faces of a panel. Barrier sheets are used to achieve a variety of goals. As examples, barrier sheets can be used to provide a decorative surface, to protect a panel from abrasion, to provide a panel with stain resistance, to help provide protection against water penetration, to provide a panel with a surface that is more receptive to receiving paint coatings or other graphic or information indicia, to provide high tensile skins to make a panel stiffer, to help make a panel more slippery, to help make a panel more skid-resistant, to help protect against pests, to help resist oxygen or other compounds in the surrounding environment, combinations of these, and the like. In many embodiments, the barrier sheet is used to protect a panel against liquid water penetration while at the same time being permeable to water vapor to allow trapped moisture to escape.

Many barrier sheets used on panels are slippery. When stacked for handling, storage, shipping, or the like, or when handling, the slippery characteristics can be a concern. Slippery panels can slip and fall, damaging the panel or a person in the proximity of a fall. A panel used in building construction, as described in U.S. Pat. Pub. Nos. 2007/0179793, 2006/0160453, and 2014/0120301, might be too slippery to stand on safely. Therefore, there is a need to make barrier sheets more skid resistant.

However, adding a skid resistant coating onto a slippery barrier sheet is not necessarily feasible. Trapped moisture is another concern associated with panels covered with a barrier sheet. A barrier sheet might be highly impermeable to liquid water, but it also is highly desirable that a barrier sheet have high permeability to water vapor. This helps protect a panel from moisture intrusion while allowing still allowing trapped moisture to escape.

The goals of improving skid resistance and allowing moisture vapor to escape often are in conflict. Many skid resistant coatings trap moisture and would not allow a panel to release moisture vapor. Even if a skid resistant coating allows water vapor to pass, the water vapor transmission rate may be too low to avoid moisture damage to the engineered wood substrate.

Accordingly, a strong demand exists for strategies that can improve the skid resistant properties of barrier sheets incorporated into engineered wood panels while at the same time allowing moisture vapor to escape.

### SUMMARY OF THE INVENTION

The present invention provides strategies that can improve the skid resistant properties of barrier sheets. As one utility, the barrier sheets may be incorporated into engineered wood panels to provide skid resistance and liquid water impermeability while at the same time allowing moisture vapor to escape. In illustrative embodiments, the barrier sheets can be formed as coatings on the panels, as pre-formed sheets that are attached to the panels, or the like. The barrier sheets become a barrier layer when applied onto one or more surfaces of a panel. The present invention is based on the concept of forming skid resistant coatings on a barrier sheet, wherein the skid resistant coating is in the form of a coated mesh. Even though the mesh covers only a fraction of the surface area of the barrier sheet, the mesh provides a surprising level of skid resistance that can rival or even exceed a full coverage skid resistant coating formed from the same coating material. Not only does the coated mesh provide high levels of skid resistance, but the substantial open areas provide ample pathways for moisture vapor to escape. The resultant barrier sheets can be used on panels suitable in interior or exterior applications.

The coated mesh provides more advantages. When formed from transparent materials, the underlying barrier sheet is observed with minimal obstruction. This allows decorative features, graphics, or other indicia to be fully observed. Ambient humidity and drying conditions during manufacture, shipping, or storing are less critical to control when moisture can still easily escape from the resultant panels. The mesh, therefore, also makes it easier to manufacture, ship, or store engineered wood panels.

As another key advantage, the use of the mesh structure is environmentally friendly in many respects. First, water-based adhesives are more feasible to use to bond the pre-coated barrier sheets to a wood panel substrate, because water vapor can still easily escape through the mesh. Also, significantly less material is used to form a mesh structure as compared to forming a full coverage coating.

In one aspect, the present invention relates to a method of making a barrier sheet bearing a skid-resistant, coated mesh, comprising the steps of:
a) providing a barrier sheet having a surface; and
b) forming a skid-resistant, coated mesh on the barrier sheet surface in a manner such that the coated mesh covers from 1% to 80% of the barrier sheet surface.

In another aspect, the present invention relates to a coated barrier sheet, comprising:
a) a barrier sheet having a surface; and
b) a skid-resistant, coated mesh provided on the surface, said coated mesh covering from 1% to 80% of the barrier sheet surface.

In one aspect, the present invention relates to a method of making a coated barrier sheet, comprising the steps of:
a) providing an engineered wood panel comprising an engineered wood substrate and a barrier sheet attached to at least a portion of a surface of the engineered wood substrate, wherein the barrier sheet comprises a barrier layer surface; and
b) causing a skid-resistant, coated mesh to be provided on the barrier layer surface, wherein the coated mesh covers from 1% to 80% of the barrier layer surface.

### BRIEF DESCRIPTION OF THE DRAWINGS

FIG. 1 is a schematic, isometric perspective view of an engineered wood panel of the present invention incorporating a coated mesh.

FIG. 2 is a schematic, cross-section view of a portion of the engineered wood panel of FIG. 1.

FIG. 3 shows a top view of an exemplary mesh structure of the present invention that mimics the tortuous fiber structure of a non-woven, fibrous fabric.

FIG. 4 shows a top view of an exemplary mesh structure of the present invention that mimics the mesh structure of a window screen or hardware cloth.

FIG. 5 shows a top view of an exemplary mesh structure of the present invention that mimics the mesh structure of FIG. 4 further incorporating angled strands.

FIG. 6 shows a top view of an exemplary mesh structure of the present invention that mimics the mesh structure of an open, woven fabric

FIG. 7 shows a top view of an exemplary mesh structure of the present invention that mimics the mesh structure of an array of geometric shapes.

FIG. 8 shows a top view of an exemplary mesh structure of the present invention that mimics the mesh structure of a filter mesh having a plain weave.

FIG. 9 shows a top view of an exemplary mesh structure of the present invention that mimics the mesh structure of a filter mesh having a twill weave.

FIG. 10 shows a top view of an exemplary mesh structure of the present invention that mimics the mesh structure of a filter mesh having a plain Dutch weave.

FIG. 11 shows a top view of an exemplary mesh structure of the present invention that mimics the mesh structure of a filter mesh having a twill Dutch weave.

FIG. 12 schematically illustrates a system for coating a mesh structure onto a barrier sheet.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated. All patents, patent applications, and publications cited herein are incorporated herein by reference in their respective entireties for all purposes. The foregoing detailed description has been given for clarity of understanding only. No unnecessary limitations are to be understood therefrom. The invention is not limited to the exact details shown and described, for variations obvious to one skilled in the art will be included within the invention defined by the claims.

All parts, percentages and ratios used herein are expressed by weight unless otherwise specified. All documents cited herein are incorporated by reference in their respective entireties for all purposes.

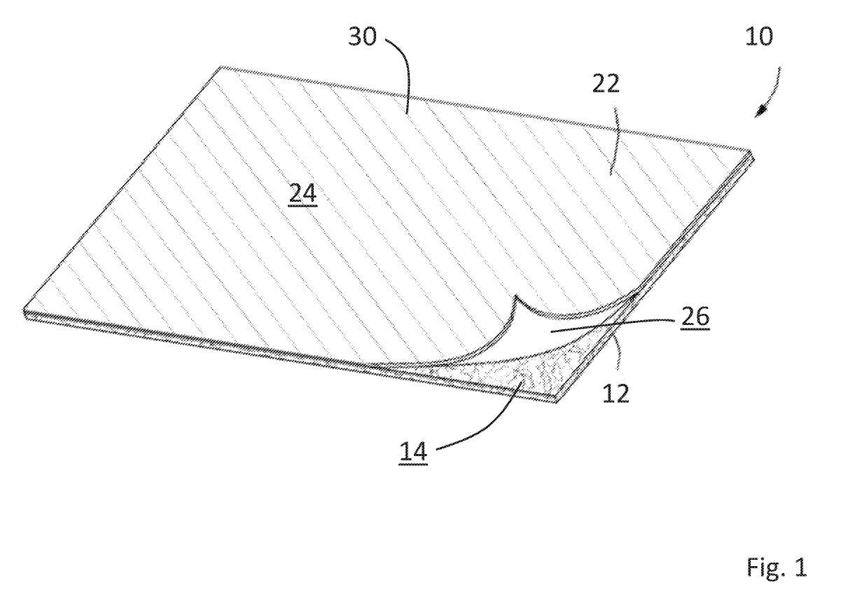

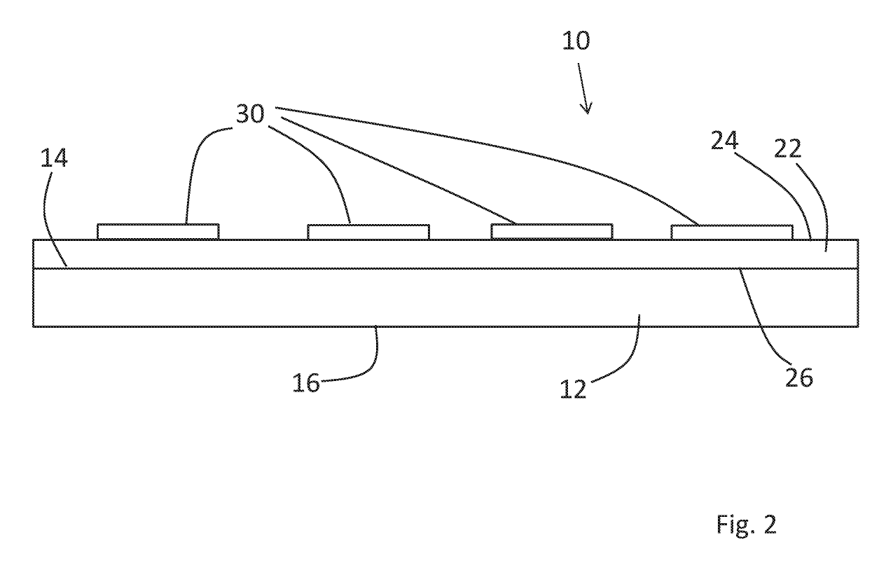

The present invention provides coated barrier sheets and corresponding engineered wood panels with skid resistant surfaces as well as methods of making such coated barrier sheets and engineered wood panels. An exemplary embodiment of an engineered wood panel 10 of the present invention is shown in FIGS. 1 and 2. Panel 10 includes an engineered wood substrate 12. Engineered wood substrate 12 is a body comprising one or more wood composite materials. A wood composite material is a material comprising a plurality of wood pieces held together in a solid body by at least one binder matrix. The wood pieces may be incorporated into the composite in one or more forms. Exemplary forms include veneer sheets, flakes, powder, strands, wafers, combinations of these, and the like. The binder matrix often includes one or more solid binder polymers. The one or more binder polymers may be thermoplastic or thermoset. In some embodiments, a combination of thermoplastic and thermoset binder polymers may be incorporated into the binder matrix. A wide variety of polymers may be used. Examples include polyesters, polyethers, polyurethanes, polyureas, polyamides, silicones, poly(meth)acrylates, polyolefins, phenol-formaldehyde-based polymers, phenol-urea-based polymers, epoxies, nitrocellulose, polysulfides, polybutadienes, polystyrenes, alkyds, melamine-formaldehyde-based polymers, melamine-urea-formaldehyde polymers, combinations of these, and the like.

In addition to the wood pieces and the binder polymers, engineered wood composites may include one or more additional components or additives. Exemplary additives include fungicides, antoxidants, bactericides, moldicides, antistatic agents, UV stabilizers, fillers, pigments, dyes, reinforcing fibers, taggants, combinations of these, and the like. Non-limiting examples of wood composite materials include oriented strand board (“OSB”), waferboard, particle board, chipboard, medium-density fiberboard, high density fiberboard, laminated veneer lumber, engineered flooring, plywood, boards that are a composite of strands and ply veneers, and the like. Example of wood composite materials are further described in the Supplement Volume to the Kirk-Othmer Encyclopedia of Chemical Technology, pp 765-810, 6th Edition and in U.S. Pat. Pub. No. 2014/0120301.

Engineered wood substrates useful in the practice of the present invention may have a wide range of shapes and sizes. For purposes of illustration, engineered wood substrate 12 is provided with a panel shape having first and second major opposed faces 14 and 16. Exemplary panels are available with thicknesses ranging from 1 mm to 200 mm or even greater thicknesses in the case of engineered wood substrates used for structural beams, supports, or the like in architecture applications. In many commercial embodiments, panels are widely available in thicknesses ranging from 1 mm to 48 mm. Such panels may be laminated, if desired, to form thicker panels.

Engineered wood substrates of the present invention may be formed from a single composite layer or from two or more composite layers. If two or more composite layers are used, these may be the same or different. If two or more composite layers are used, the different layers may be oriented in one or more directions relative to each other. For purposes of illustration, substrate 12 is shown as being formed with a single composite layer.

Exemplary panels also are commercially available in a range of widths (W) and lengths (L). In some embodiments, a panel has a width in the range from 5 mm to 1800 mm. In some embodiments, a panel has a length in the range from 25 mm to 6100 mm. In home improvement centers, exemplary panels may be commercially procured in widths in the range from 300 mm to 1525 mm and lengths in the range from 300 mm to 2440 mm. Such commercially available sheets may be machined to form smaller panel components, or they may be assembled to form larger panels. Scarf joints are one way in which smaller panels can be joined to form longer panels. Lamination is one way to make thicker panels.

A barrier layer in the form of a pre-formed barrier sheet 22 is secured to at least a portion of the first major surface 14 of the engineered wood substrate 12. Barrier sheet 22 has outward facing surface 24 and inward facing surface 26. Barrier sheet 22 can be used for a variety of purposes such as to provide substrate 12 with a decorative surface, to protect substrate 12 from abrasion, to provide substrate 12 with stain resistance, to help provide protection against water penetration, to provide substrate 12 with a surface that is more receptive to receiving paint coatings or other graphic or information indicia, to provide high tensile skins to make substrate 12 stiffer, to help make surface 14 more slippery, to help make surface 14 more skid-resistant, to help protect against pests, to help resist oxygen or other compounds in the surrounding environment, combinations of these, and the like. In many embodiments, the barrier sheet 22 is used to protect substrate 12 against liquid water penetration while at the same time being permeable to water vapor.

The barrier sheet 22 can have a solid or substantially solid structure. For example, barrier sheet 22 may be a solid film or may have an open or otherwise porous structure, e.g., a woven and/or non-woven mat or cloth of fibers. The barrier sheet 22 can be perforated or non-perforated. Barrier sheet 22 can be formed from one or more layers. For purposes of illustration, barrier sheet 22 is shown as being formed from a single layer.

Barrier sheet 22 may be formed from a wide range of materials. Suitable materials for forming a solid structure and/or a woven or non-woven barrier sheet 22 can include, but are not limited to, cellulosic material(s), polymeric material(s), glass, carbon, powder coatings, metal or metal alloys or intermetallic materials, hydrocarbons (e.g. tar paper), felt, resin or other kinds of impregnated papers, fiber-reinforced composites, or combinations thereof. One or more polymers incorporated into barrier sheet 22 include polyesters, polyethers, polyurethanes, polyureas, polyamides, silicones, poly(meth)acrylates, polyolefins, phenol-formaldehyde-based polymers, phenol-urea-based polymers, epoxies, nitrocellulose, polysulfides, polybutadienes, polystyrenes, alkyds, melamine-formaldehyde-based polymers, melamine-urea-formaldehyde polymers, combinations of these, and the like.

In at least one embodiment, the barrier sheet 22 and/or one or more individual layers of the barrier sheet 22 can include one or more cellulosic fibers and/or one or more polymer fibers, and optionally, one or more additives. Illustrative embodiments of these include the air-laid sheets or mats described in U.S. Pat. Pub. No. 2014/0120301. In many instances, air-laid sheets are highly permeable to water. U.S. Pat. Pub. No. 2014/0120301 describes how to make air-laid sheets that are water-resistant.

Illustrative resin impregnated papers useful to form all or a portion of barrier sheet 22 can include paper impregnated with phenol-formaldehyde resin, modified phenol-formaldehyde resin, or other suitable resin(s). For example, resin-impregnated crepe paper can be used to make high density overlay sheets. Resin-impregnated kraft paper can be used to make medium density overlay sheets. Many embodiments of the resin impregnated papers are made by saturating a kraft or crèpe paper with a thermosetting resin and then curing the resin. Suitable high and medium-density overlays are disclosed in U.S. Pat. No. 5,116,446 and U.S. Pat. No. 5,089,348. Illustrative embodiments of high and medium-density overlay may have a weight of about 25 lbs./msf to about 75 lbs./msf and a resin content of about 1% to about 60%, preferably 20% to about 60% by dry weight based on the total weight of the resultant impregnated paper. Other commercially available embodiments of barrier sheets are available from the paper laminate product lines of Omnova Solutions, Monroe, N.C.

Barrier sheet 22 may have a thickness selected from a wide range. In many embodiments, barrier sheet 22 has a thickness in the range from 0.0005″ (0.01 mm) to about 0.125″ (3.2 mm).

The liquid water transmission rate (LWTR) of barrier sheet 22 may be measured with respect to barrier sheet 22 alone (the nominal LWTR of barrier sheet 22), with respect to barrier sheet 22 having coated mesh 30 applied but prior to being secured to substrate 12 (the coated LWTR of barrier sheet 22), or with respect to barrier sheet 22 having coated mesh 30 applied and after being secured to substrate 12 (the composite LWTR of barrier sheet 22). In the practice of the present invention, the nominal, coated and composite LWTR values of barrier sheet 22 are determined via a Cobb ring according to ASTMD5795. The barrier sheet 22 is deemed to be liquid water-impermeable if the nominal LWTR is equal to or less than 32 g/m²/24 hours, preferably equal to or less than 28 g/m²/24 hours, more preferably equal to or less than 25 g/m²/24 hours, even more preferably equal to or less than 20 g/m²/24 hours. The barrier sheet 22 is deemed to be liquid water-permeable if the nominal LWTR is greater than 32 g/m²/24 hours, preferably greater than 28 g/m²/24 hours, more preferably greater than 25 g/m²/24 hours, even more preferably greater than 20 g/m²/24 hours. In some embodiments, barrier sheet 22 has a nominal LWTR as low as 5 g/m²/24 hours, preferably as low as 3 g/m²/24 hours, more preferably as low as 2 g/m²/24 hours, or even as low as 0.5 g/m²/24 hours. In many instances, the coated and composite LWTR values of barrier sheet 22 are less than the nominal LWTR. This means that the coated and/or composited barrier sheet 22 generally is more liquid water impermeable than the nominal barrier sheet 22.

Barrier sheet 22 may be liquid water-impermeable or liquid water-permeable. In many embodiments, barrier sheet 22 is liquid water-impermeable.

The water vapor transmission rate (WVTR) of barrier sheet 22 may be measured with respect to barrier sheet 22 alone (the nominal WVTR of barrier sheet 22), with respect to barrier sheet 22 having coated mesh 30 applied but prior to being secured to substrate 12 (the coated WVTR of barrier sheet 22), or with respect to barrier sheet 22 having coated mesh 30 applied and after being secured to substrate 12 (the composite WVTR of barrier sheet 22). In the practice of the present invention, the nominal, coated and composite WVTR values of barrier sheet 22 are determined at 22.8° C. at 50% relative humidity (RH) according to ASTM E96 Procedure A. The barrier sheet 22 is deemed to be water vapor-impermeable if the nominal WVTR is equal to or less than 5.0 g/m²/24 hours, preferably equal to or less than 2.0 g/m²/24 hours, more preferably equal to or less than 1.0 g/m²/24 hours, even more preferably equal to or less than 0.1 g/m²/24 hours. The barrier sheet 22 is deemed to be water vapor-permeable if the nominal WVTR is greater than 5.0 g/m²/24 hours, preferably greater than 2.0 g/m²/24 hours, more preferably greater than 1.0 g/m²/24 hours, even more preferably greater than 0.1 g/m²/24 hours. In some embodiments, barrier sheet 22 has a nominal WVTR as high as as 6 g/m²/24 hours, preferably as high as 7.5 g/m²/24 hours, more preferably as high as 8.5 g/m2/24 hours, or even as high as 9.0 g/m²/24 hours. In many instances, the coated and composite WVTR values of barrier sheet 22 are less than the nominal WVTR. This means that the coated and/or composited barrier sheet 22 generally are less water vapor permeable than the nominal barrier sheet 22.

Barrier sheet 22 may be water vapor-impermeable or water vapor-permeable. In many embodiments, barrier sheet 22 is water vapor-permeable.

In many preferred embodiments, barrier sheet 22 is both liquid water-impermeable and moisture vapor-permeable. Such embodiments protect engineered wood substrate 12 against water penetration while at the same time allowing water vapor to escape from engineered wood substrate 12. Many commercially available films are both liquid water-impermeable and moisture vapor-permeable. An example of a suitable barrier sheet 22 of this type is commercially available from Omova Solutions, North Carolina, under the paper laminate product lines. Other commercially available films of this type include the GreenGuard® Value Building Wrap™ and GreenGuard® Max Building Wrap, each sold by the Pactiv Corporation, and the Tyvek® Building Wrap sold by the DuPont Company (also known as E.I. Du Pont de Nemours and Company).

The dry coefficient of friction (COF) of barrier sheet 22 may be measured with respect to barrier sheet 22 alone (the nominal COF), with respect to barrier sheet 22 having coated mesh 30 applied but prior to being secured to substrate 12 (the coated COF), or with respect to barrier sheet 22 having coated mesh 30 applied and after being secured to substrate 12 (the composite COF). In the practice of the present invention, the nominal, coated and composite COF values of barrier sheet 22 are determined according to ASTM D 202 using a Model32-25 COF Tester available from Testing Machines, Inc. of New Castle, Del. Barrier sheet 22 can be quite slippery when its nominal COF is about 0.5 g or less, such as being in the range from 0.1μ to 0.45μ. Advantageously, the skid resistant coated mesh 30 as one advantage helps to increase the COP without unduly compromising the nominal, coated, or composite WVTR characteristics of barrier sheet 22. With coated mesh 30, the coated COF desirably is at least 0.6, more preferably at least 0.7, more preferably at least 0.8, and more preferably at least 0.9. In many embodiments, the coated COF would be 1.2 or less, or in some instances 1.1 or less.

Barrier sheet 22 is secured to at least a portion of the first major surface 14 of engineered substrate 12. Barrier sheet 22 can be secured to substrate 12 in a variety of different ways such as by using mechanical fasteners, physical coupling (e.g., sheet 22 is softened or melted to interlock with the surface topography of substrate 12, adhesion such as by self-adhesion or use of a separate adhesive layer, or the like. For purposes of illustration, barrier sheet 22 is secured to substrate 12 using self-adhesive properties so that a separate adhesive layer is not shown. Preferably in those embodiments in which barrier sheet 22 is liquid water-impermeable and moisture vapor-permeable film, adhesive layer 28 also is liquid water-impermeable and moisture-vapor permeable adhesive. By selecting sheet 22 and adhesive 28 that are both water-impermeable and moisture-vapor permeable, the resulting protection barrier helps to prevent liquid water from penetrating into the substrate. The combination also helps to allow liquid water that does penetrate to be eliminated because the moisture-vapor permeable characteristics of the barrier sheet 22 and adhesive 28 allow water to pass through and thereby evaporate out of the substrate 12.

A coated mesh 30 is provided on the top surface 24 of barrier sheet 22. Coated mesh 30 is seen best in FIG. 2 and is schematically represented in FIG. 1 by hatching lines. As used herein, a “mesh” refers to a coated texture comprising one or more coated strands deployed in a manner such that the underlying barrier sheet 22 is exposed to the ambient though a plurality of openings whose boundaries are defined at least in part by the strands. The strands may be deposited in linear, zig-zag, curved, tortuous, or other shapes. The strands may extend only across a portion of the surface 24 such that both first and second ends of a strand are located within the area of top surface with the first and second ends being spaced apart and not contacting edges of the panel 10. Alternatively, one or both ends of a strand may be at one or more edges of panel 10. The strands may be deployed in a manner effective to provide mesh elements that may be interconnected with one or more other mesh elements or that may be isolated from other mesh elements.

Coated mesh 30 has a three dimensional topography that mimics a mesh that is pre-formed and then laminated or otherwise secured to barrier sheet 22. Instead of being pre-formed and then secured to barrier sheet 22, coated mesh 30 is formed by coating at least one fluid composition onto barrier sheet 22 and then curing the coated composition and optionally one or more other ingredients to form the desired coated mesh structure 30. Curing may occur by physical phenomena (e.g., drying, cooling from a molten state, physically crosslinking, and/or the like), by chemical phenomena (e.g., chemical crosslinking that is assisted by one or more optional agents such as catalysts, crosslinkers, initiators, heat, electron beam energy, ultraviolet energy, infrared eneregy, acoustic energy, pressure, laser energy, and/or the like), or any other suitable curing technique(s).

As used herein, a strand refers to a coated feature having an aspect ratio of at least 5:1, more preferably at least 10:1, even more preferably at least 100:1, or even at least 1000:1, or even at least 10,000:1. There is no real upper limit on the aspect ratio except for a practical limit that strands should not be so long and tortuous that too much of the surface 24 of barrier sheet 22 would end up being coated so that open characteristics of the mesh 30 are compromised. For example, one embodiment of a coated strand could wind back and forth across surface 24 tens or hundreds or even thousands of times before terminating. In some embodiments, the aspect ratio of a coated strand is less than 100,000:1, even less than 50:000;1, or even less than 25,000:1, or even less than 10,000:1.

Coated strands may have a side to side width and top to bottom thickness independently selected from wide ranges. Selecting suitable dimensions for the width and thickness of strands may depend on factors such as the durability of strands that are too thin, ensuring that the coated mesh has sufficient open areas through which the underlying barrier sheet 22 are exposed, the degree of skid resistance desired, the inherent skid resistant and other properties of the material(s) used to form mesh 30, the skid resistant properties contributed by the mesh topography, the curing technique(s) used to form mesh 30, the nature of surface 24, the intended end use of panel 10 or portions thereof, and the like. Balancing such concerns, the width and thickness of strand features of mesh 30 independently may be in the range from 0.008 inches to 0.012 inches, preferably 0.003 inches to 0.009 inches, more preferably 0.003 inches to 0.006 inches.

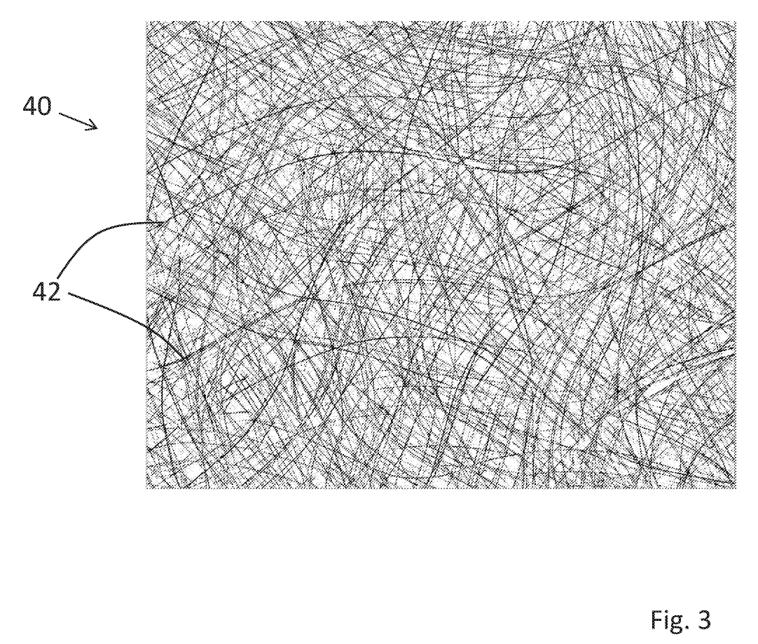

Coated mesh 30 may have a coating weight selected from a wide range. In some embodiments, the cured coated mesh 30 has a coated weight in the range from 10 g/m² to 1000 g/m². In one mode of practice that involves a mesh structure according to FIG. 3, a coated weight of 30 m²/g was suitable.

Coated mesh 30 is formed on surface 24 of barrier sheet 22 such that the mesh comprises a plurality of open spaces through which the underlying barrier sheet 22 is exposed to the ambient. Advantageously, this allows coated mesh 30 to be applied in a manner to help increase the COF characteristics of surface 24, making surface 24 less slippery. At the same time, the open characteristics of mesh 30 allow barrier sheet 22 to breath and release water vapor to help avoid trapping moisture in panel 10.

Desirably, a coated barrier sheet 22 has a coated WVTR that is in the range from 20% to 100%, preferably 50% to 95% of the nominal WVTR of barrier sheet 22. The impact of the mesh 30 upon the WVTR of barrier sheet 22 can be tuned by increasing the open areas to maintain a higher level of WVTR or by decreasing the amount of open areas to maintain a lower level of WVTR. Open areas can be increased by using thinner strands to form the coated mesh 30 and/or by coating strands at a lower strand density. Open areas can be decreased by using thicker strands to form the coated mesh 30 or by depositing strands with a greater strand density.

A distinct advantage of using a coated mesh 30 is that the mesh 30 can provide significant gains in COF relative to the uncoated barrier sheet even when very large portions of barrier sheet 22 are exposed through open areas of mesh 30. Counterintuitively, the coated mesh 30 could even provide a level of skid resistance that rivals or exceeds the skid resistance provided by a continuous coating formed of the same material(s). In other words, a coated mesh provides a surprising level of skid resistance without unduly choking the ability of the panel 10 to release moisture. In contrast, a continuous skid resistant coating applied over substantially all of barrier sheet 22 might provide high levels of skid resistance. However, a continuous, skid resistance coating could choke the barrier sheet 22 too much to cause the coated WVTR to be lower than desired for good moisture abatement.

For example, in illustrative embodiments of the present invention, the coated COF of barrier sheet 22 bearing mesh 30 is at least 1.2 times greater than the nominal COF of barrier sheet 22. In some embodiments, the coated COF of barrier sheet 22 bearing mesh 30 is from 1.2 times greater to 5 times greater than the nominal COF of barrier sheet 22. In one experiment, a barrier sheet 22 had a nominal COF of 0.5. When coated with a mesh having the mesh structure shown in FIG. 3 below, about 24% of the surface area of the barrier sheet was covered by the tortuously winding strands, and about 76% of the underlying barrier sheet 22 was exposed through the corresponding open areas of the mesh. The coated barrier sheet had a coated COF of 0.90 to 1.0.

Without wishing to be bound by theory, a rationale to explain the surprising level of skid resistance of mesh 30 can be suggested. In contrast to a mesh, a continuous, skid resistant coating relies mainly upon the inherent skid resistant properties of the coating itself. The mesh, however, gets skid resistance both from the material itself as well as from the topography of the mesh. The grippy nature of the mesh is analogous to the grip offered by the tread on a tire. This theory is borne out by tests in which the shape of the mesh elements had a significant impact on the COF characteristics of a barrier sheet.

Coated mesh 30 may be formed one or more skid-resistant coating compositions that can be coated in fluid form and then cured to form the solid mesh 30. A wide range of skid resistant coating compositions are commercially available from a wide number of commercial sources. One class of suitable skid resistant compositions are commercially available as skid resistant, overprint varnishes. These have the advantage of being highly transparent to allow the visual appearance of barrier sheet 22 to be observed through both the open areas and strands of mesh 30. Many overprint varnishes incorporate one or more film forming polymers. These may be thermoplastic and/or thermosetting. For indoor use, the polmers may be aliphatic and/or aromatic. For outdoor use, aliphatic polymers are more desirable. The overprint varnishes may be supplied without solvent, where one or more ingredients of the coating composition function as a reactive diluent for the composition but then readily cure after coating to from the solid composition. Other overprint varnishes include solvent that dries during curing of the composition. Both water-based and organic solvent-based compositions are available.

Optionally, an overprint varnish composition may include one or more additives to help improve manufacturability, storage, use, or coating performance. Examples of additives include pigments, dyes, fillers, skid resistant agents, antistatic agents, fungicides, bactericides, moldicides, antioxidants, ultraviolet protection agents, dispersants, lubricants, thickening agents, flow control additives, antifoaming agents, combinations of these, and the like. Examples of commercially available, skid-resistant overprint varnishes include the Joncryl® 537 and 60 overprint varnishes available from BASF: the Michem® Emulsion 91735 and 94340 overprint varnishes available from Michelman, Inc.; the Revalux® 153 gloss varnish 0169, Revalux® 153 gloss varnish 0169-1, and the Reflux® 130 friction varnish 0141 available from Resino Trykfarver A/S. Additional overprint varnishes with skid resistant properties are available from PPG Industries (Teslin Substrate Products Business) and Sun Chemical (part of the DIC Group).

Other kinds of skid resistant coatings with less transparency than an overprint varnish may be used. These include the Valspar® Skidnot® skid resistant coating; the Rust-Oleum AntiSlip slip resistant coating; and the Carbonyte Systems Inc. SkidGard skid-resistant coating.

A variety of coated meshes may be used as coated mesh 30. One exemplary embodiment of a mesh structure 40 is shown in FIG. 3 mimics the tortuous fiber structure of a non-woven, fibrous fabric. Mesh structure 40 includes a plurality of strands 42 that start on an edge of the structure and tortuously curve across the panel to terminate on another edge. The strands 42 are oriented in multiple directions. Advantageously, this allows the mesh structure 40 to provide improved skid resistance in all directions across the surface of a barrier sheet (not shown) onto which the mesh structure 40 is provided.

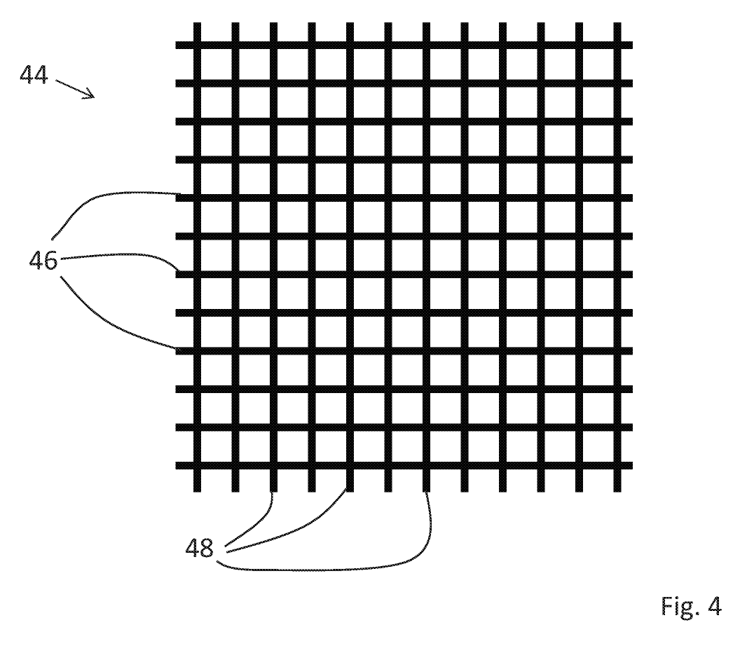

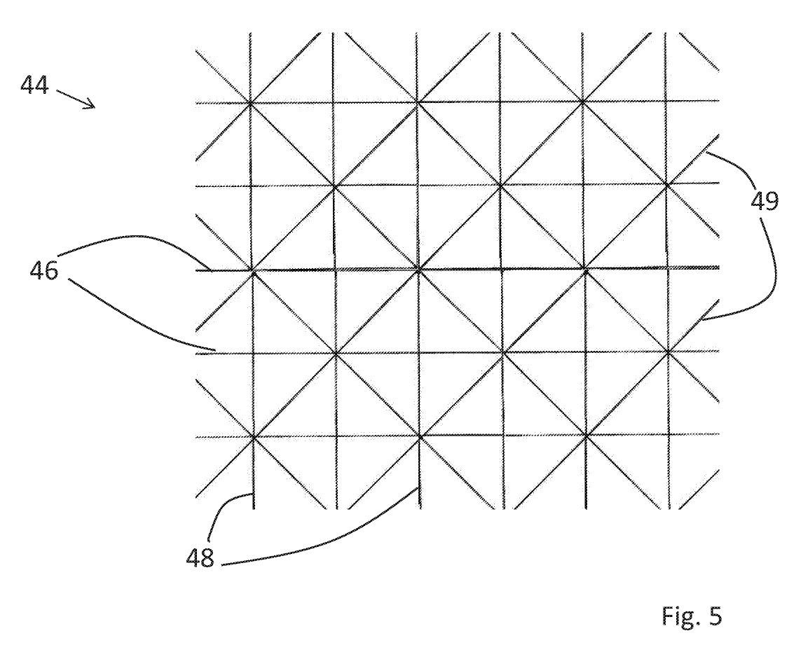

Another embodiment of a mesh structure 44 is shown in FIG. 4. Mesh structure 44 comprises a plurality of strands 46 and 48 that are generally perpendicular to each other and that form a generally rectangular mesh structure. This structure mimics that of a window screen or hardware cloth. FIG. 5 shows a modification of mesh structure 44 further including angled strands 49.

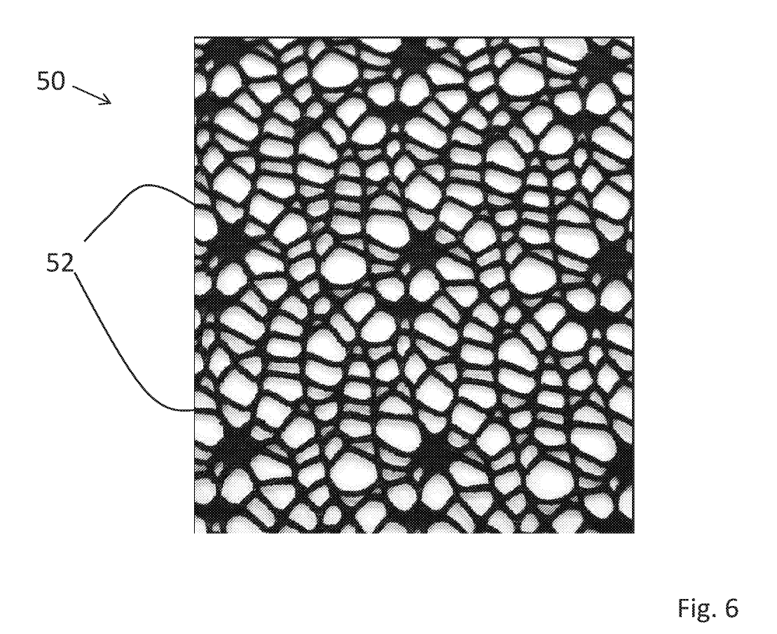

Another mesh structure 50 is shown in FIG. 6. This mesh structure 50 comprises a plurality of strands 52 such that mesh structure 50 mimics an open, woven fabric.

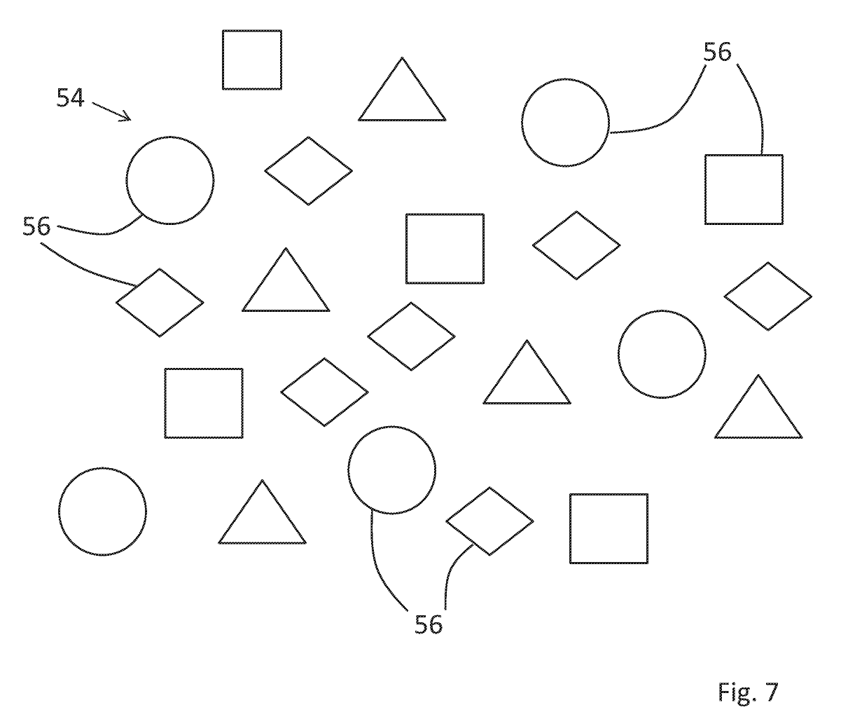

Another mesh structure 54 is shown in FIG. 7. Mesh structure 54 comprises coated strands 56 that are deployed in a manner effective to provide an array of discrete, geometric shapes.

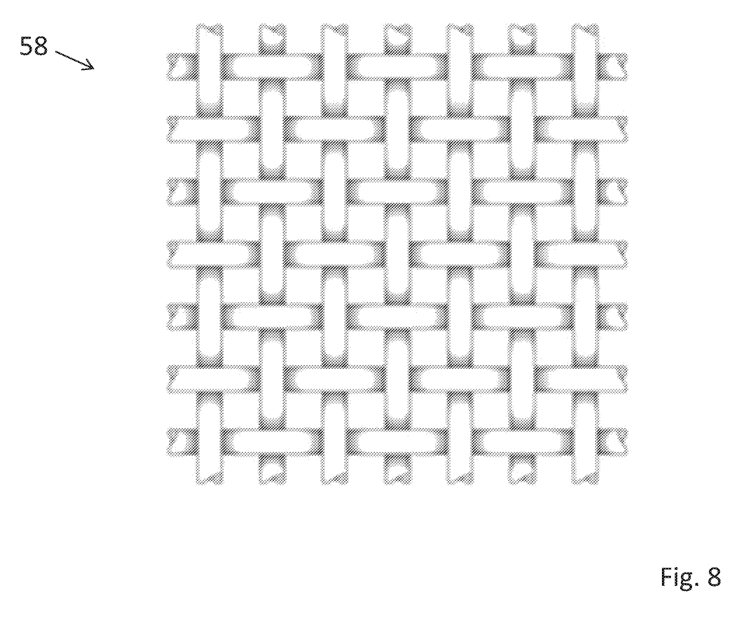

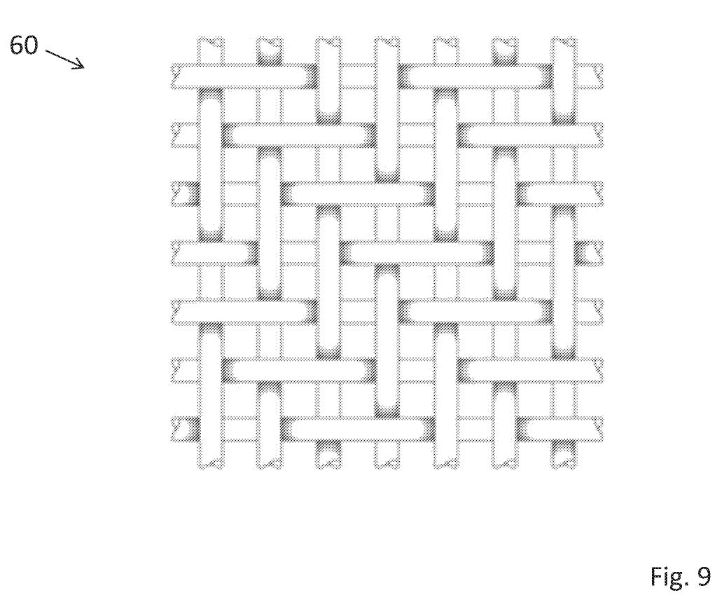

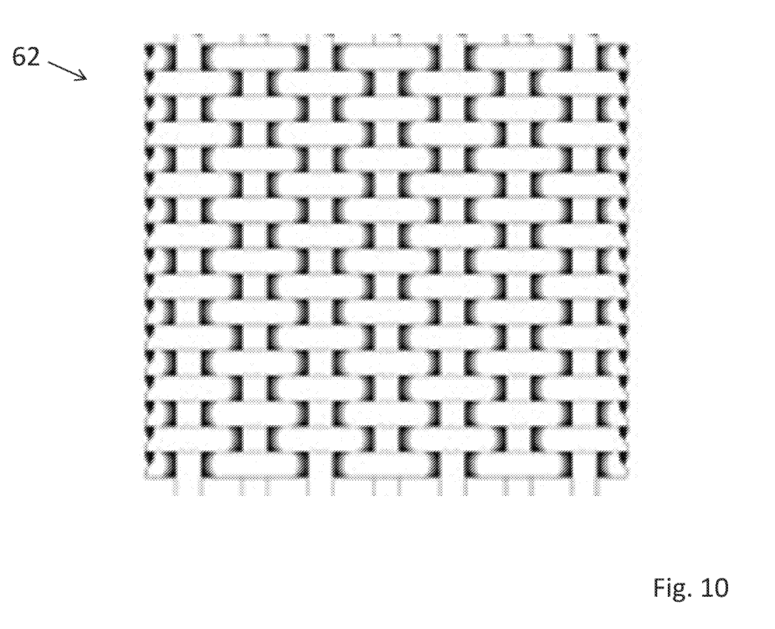

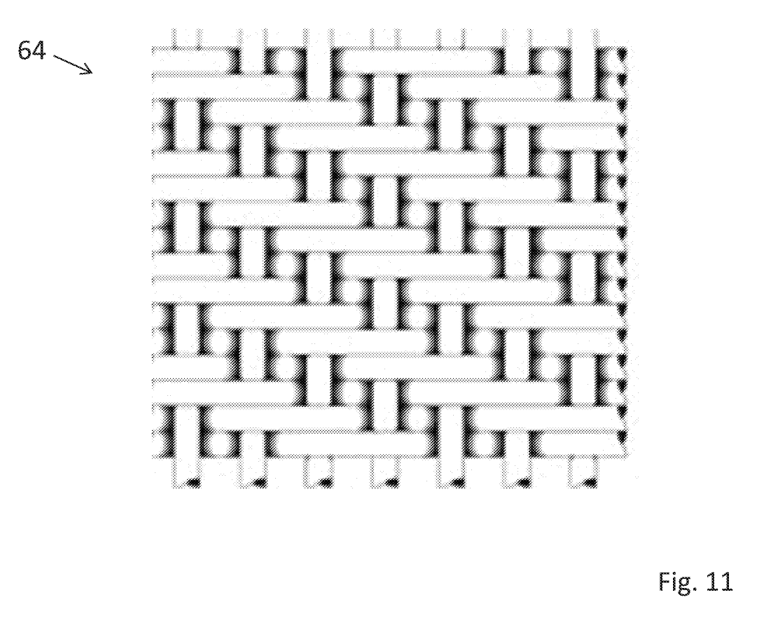

Other exemplary mesh structures useful in the practice of the present invention mimic filter meshes. For example, FIGS. 8 to 11 each shows a mesh structure 58, 60, 62, and 64, respectively, that mimic filter meshes having a plain weave, twill weave, plain Dutch weave, and twill Dutch weave, respectively.

Engineered wood panels of the present invention may be manufactured using a wide range of techniques. According to one exemplary mode of practice, an engineered wood panel of the present invention is prepared by forming a coated mesh onto a pre-existing assembly that already includes a barrier sheet attached to an engineered wood substrate. Practice of this method is useful to help increase the COF of the panel. For example, an engineered wood substrate and a barrier sheet are provided. The barrier sheet has a nominal COF. The barrier sheet is secured to the engineered wood substrate to form an intermediate assembly. Optionally, a barrier sheet can be applied to both major faces of the engineered wood substrate if desired. Next, a skid resistant coated mesh of the present invention is applied onto the barrier sheet to form the engineered wood panel.

In other modes of practice, an engineered wood panel of the present invention can be prepared by using an alternative sequence in which the coated mesh is first applied to the barrier sheet. Practice of this method also is useful to help increase the COF of the panel. According to this approach, a barrier sheet is provided. The barrier sheet has a nominal COF.

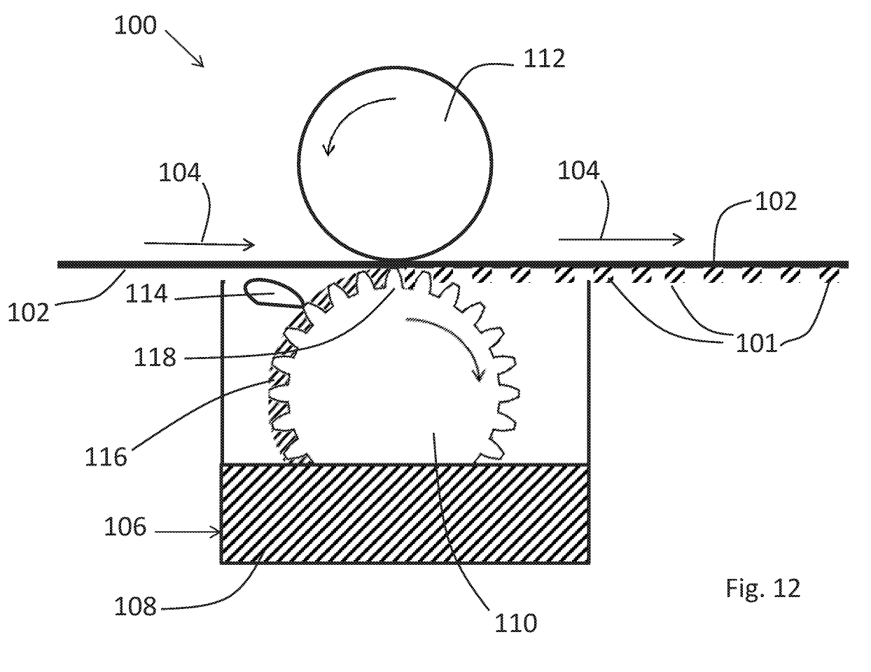

Next, a coated mesh of the present invention is formed on the barrier sheet. This is accomplished by coating a fluid composition onto the sheet and then curing the composition to form the mesh structure. Many coating techniques can be applied in order to selectively coat the composition onto the barrier sheet to from a mesh structure. Exemplary techniques include screen printing; spraying, brushing, curtain coating or otherwise applying the coating composition through a mask; using positive or negative resist methods to form the image; gravure coating; flexographic printing; inkjet printing; laser printing; or the like. For purposes of illustration, FIG. 12 shows an exemplary gravure coating system 100 for forming a coated mesh 101 on a barrier sheet 102.

In FIG. 12, barrier sheet 102 is conveyed in the direction of arrows 104 from a supply roll (not shown) to a take-up roll (not shown). Coating station 106 is used to help form the coated mesh structure. Station 106 includes a vessel holding a bath 108 comprising a fluid coating composition. A coating roller 110 is rotatably mounted so that a lower portion of the roller passes through bath 108 while an upper portion is out of bath 108 and contacts the side of barrier sheet 102 to be coated. The surface of the coating roller 110 is engraved with a pattern corresponding to the mesh structure to be coated onto barrier sheet 102. A pressure roller 112 is rotatably positioned on the other side of barrier sheet 102 to press barrier sheet into contact with coating roller 110. A doctor blade 114 is positioned to remove excess coating composition from coating roller 110 after a coated portion of roller 110 emerges from bath 108 and before the coated portion of roller 110 contacts the barrier sheet 102.

In an exemplary coating operation, barrier sheet 102 is conveyed from the supply roll (not shown) to the take up roll (not shown). At station 106, the rotating pressure roller 112 presses the moving barrier sheet 102 into contact with the rotating coating roller 110. As roller 110 rotates, a lower portion of roller 110 is submerged in bath 108. As roller 110 rotates, a side 116 emerges from the bath that is loaded with the coating composition. As the side 116 continues to rotate toward the surface of the barrier sheet to be coated, doctor blade 114 squeegees off the surface of side 116 to remove excess coating composition. Generally, this leaves coating composition in the engraved recesses, but otherwise removes the coating composition from side 116. As roller 110 continues to rotate, a portion 118 comes into contact with barrier sheet 102 and prints the engraved mesh 101 onto barrier sheet 102 to form the desired mesh structure. The pressure of pressure roller 112 may be adjusted as needed so that the engraved pattern on the surface of roller 110 is printed onto barrier sheet 102 as mesh 101 with high resolution. Downstream from station 106, one or more additional stations (not shown) may be used to help cure and solidify the mesh structure on barrier sheet 102.

Downstream from the coating and curing stations, the coated barrier sheet is taken up and stored on a take up roll or otherwise packaged and stored prior to further use. Subsequently, the coated barrier sheet is attached to at least a portion of an engineered wood substrate in order to form an engineered wood panel of the present invention. A coated barrier sheet or an uncoated barrier sheet optionally may be attached to the other major face of the substrate, if desired. Optional release liners may be used to help prevent the coated mesh from sticking (also known as blocking) while in storage. As one alternative to storing the coated sheet on a take up roll or package before further use, the coated barrier sheet may be conveyed directly to a station in which the barrier sheet is applied to an engineered wood substrate.

Regardless of which method is used to prepare an engineered wood panel of the present invention, the resultant panel or the components of the panel optionally can be cut into desired panel sizes and shapes at one or more stages of manufacture, as desired. For example, engineered wood substrates can be cut into desired shapes and sizes before the barrier sheet is secured to the substrate. As another option, an assembly of the substrate and barrier sheet can be cut into desired shapes and sizes prior to applying the coated mesh. As another option, the finished engineered wood panel can be cut into desired shapes and sizes. As still another alternative, a coated barrier sheet can be cut into desired shapes or sizes prior to being attached to a substrate.

Regardless of which method is used to prepare an engineered wood panel of the present invention, the coated mesh advantageously increases the skid resistance of the resultant panel without unduly choking the WVTR. For example, in many illustrative embodiments, the composite COF of the panel is in the range from 1.2 to 5 times the nominal COF of the barrier sheet. Also, the composite WVTR is in the range from 20% to 100%, or even 30% to 95%, or even 50% to 95% of the nominal WVTR of the barrier sheet.

In some embodiments, the present invention relates to a method of increasing the coefficient of friction of an engineered wood panel, comprising the steps of: (a) providing an engineered wood panel comprising an engineered wood substrate and a barrier sheet as described herein that is attached to at least a portion of a surface of the engineered wood substrate, wherein the barrier sheet comprises a barrier layer surface; and (b) causing a skid-resistant, coated mesh to be provided on the barrier layer surface, wherein the coated mesh covers from 1% to 80% of the barrier layer surface.

In some embodiments, the present invention relates to a method of making an engineered wood panel, comprising the steps of (a) providing a coated barrier sheet having (1) a barrier layer surface, and (2) a skid-resistant, coated mesh provided on the barrier layer surface in a manner such that the coated mesh covers from 1% to 80% of the barrier layer surface; and (b) attaching the coated barrier sheet to at least a portion of a major surface of an engineered wood substrate.

In some embodiments, the present invention also relates to an engineered wood panel, comprising (a) an engineered wood substrate having first and second opposed major surfaces; (b) a barrier sheet on at least a portion of the first major surface of the engineered wood substrate, wherein the barrier sheet has a surface; and (c) a skid-resistant, coated mesh provided on the barrier sheet surface in a manner such that the coated mesh covers from 1% to 80% of the barrier layer surface.

In some embodiments of the engineered wood panels, or in some embodiments of methods of making the engineered wood panels, the barrier sheet comprises a film.

In some embodiments of the engineered wood panels, or in some embodiments of methods of making the engineered wood panels, the barrier sheet comprises a porous structure.

In some embodiments of the engineered wood panels, or in some embodiments of methods of making the engineered wood panels, the barrier sheet comprises woven fibers.

In some embodiments of the engineered wood panels, or in some embodiments of methods of making the engineered wood panels, the barrier sheet comprises non-woven fibers.

In some embodiments of the engineered wood panels, or in some embodiments of methods of making the engineered wood panels, the barrier sheet comprises impregnated paper.

In some embodiments of the engineered wood panels, or in some embodiments of methods of making the engineered wood panels, the barrier sheet comprises paper impregnated with a resin selected from a phenol-formaldehyde resin and a modified phenol-formaldehyde resin.

In some embodiments of the engineered wood panels, or in some embodiments of methods of making the engineered wood panels, the barrier sheet is liquid water impermeable.

In some embodiments of the engineered wood panels, or in some embodiments of methods of making the engineered wood panels, the barrier sheet is water vapor permeable.

In some embodiments of the engineered wood panels, or in some embodiments of methods of making the engineered wood panels, the barrier sheet is liquid water impermeable and water vapor permeable.

In some embodiments of the engineered wood panels, or in some embodiments of methods of making the engineered wood panels, the skid-resistant, coated mesh comprising a three dimensional topography.

In some embodiments of the engineered wood panels, or in some embodiments of methods of making the engineered wood panels, the three dimensional topography mimics a preformed mesh.

In some embodiments of the engineered wood panels, or in some embodiments of methods of making the engineered wood panels, the coated mesh comprises a plurality of strands having an aspect ratio in the range from 5:1 to 10,000:1.

In some embodiments of the engineered wood panels, or in some embodiments of methods of making the engineered wood panels, the coated mesh comprises a tortuous fiber structure.

In some embodiments of the engineered wood panels, or in some embodiments of methods of making the engineered wood panels, the coated mesh comprises a plurality of open spaces through which the underlying barrier sheet is exposed to the ambient.

In some embodiments of the engineered wood panels, or in some embodiments of methods of making the engineered wood panels, the coated barrier sheet has a coated coefficient of friction that is at least 1.2 times greater than the nominal coefficient of friction of the barrier sheet.

In some embodiments of the engineered wood panels, or in some embodiments of methods of making the engineered wood panels, the coated barrier sheet has a coated coefficient of friction in the range from 0.90 to 1.0.

In some embodiments of the methods of making the engineered wood panels, step (b) comprises using an overprint varnish to form the coated mesh.

In some embodiments of the engineered wood panels, or in some embodiments of methods of making the engineered wood panels, the coated mesh comprises a plurality of open spaces and a plurality of strands and wherein the coated mesh is transparent to allow the visual appearance of the barrier sheet to be observed through the open spaces and the strands.

In some embodiments of methods of making the engineered wood panels, step (b) comprises uses a roller to print the coated mesh onto the barrier sheet, wherein the roller comprises an engraved pattern corresponding to the coated mesh structure.

All patents, patent applications, and publications cited herein are incorporated by reference in their respective entireties for all purposes. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A method of making a barrier sheet bearing a skid-resistant, coated mesh, comprising the steps of:
a) providing a barrier sheet having a surface; and
b) forming a skid-resistant, coated mesh that comprises a tortuous fiber structure on the barrier sheet surface in a manner such that the coated mesh covers from 1% to 80% of the bather sheet surface.

2-20. (canceled)

21. A coated barrier sheet, comprising:
a barrier sheet having a surface; and
a skid-resistant, coated mesh that comprises a tortuous fiber structure provided on the surface, said coated mesh covering from 1% to 80% of the barrier sheet surface.

22. The coated barrier sheet of claim 21, wherein the barrier sheet comprises a film.

23. The coated barrier sheet of claim 21, wherein the barrier sheet comprises a porous structure.

24. The coated barrier sheet of claim 21, wherein the barrier sheet comprises woven fibers.

25. The coated barrier sheet of claim 21, wherein the barrier sheet comprises non-woven fibers.

26. The coated barrier sheet of claim 21, wherein the barrier sheet comprises impregnated paper.

27. The coated barrier sheet of claim 21, wherein the barrier sheet comprises paper impregnated with a resin selected from a phenol-formaldehyde resin and a modified phenol-formaldehyde resin.

28. The coated barrier sheet of claim 21, wherein the barrier sheet is liquid water impermeable.

29. The coated barrier sheet of claim 21, wherein the barrier sheet is water vapor permeable.

30. The coated barrier sheet of claim 21, wherein the barrier sheet is liquid water impermeable and water vapor permeable.

31. The coated barrier sheet of claim 21, wherein the skid-resistant, coated mesh comprising a three dimensional topography.

32. The coated barrier sheet of claim 31, wherein the three dimensional topography mimics a preformed mesh.

33. The coated barrier sheet of claim 21, wherein the coated mesh comprises a plurality of strands having an aspect ratio in the range from 5:1 to 10,000:1.

34. (canceled)

35. The coated barrier sheet of claim 21, wherein the coated mesh comprises a plurality of open spaces through which the underlying barrier sheet is exposed to the ambient.

36. The coated barrier sheet of claim 21, wherein the coated barrier sheet has a coated coefficient of friction that is at least 1.2 times greater than the nominal coefficient of friction of the barrier sheet.

37. The coated barrier sheet of claim 21, wherein the coated barrier sheet has a coated coefficient of friction in the range from 0.90 to 1.0.

38. The coated barrier sheet of claim 21, wherein the coated mesh comprises a plurality of open spaces and a plurality of strands and wherein the coated mesh is transparent to allow the visual appearance of the barrier sheet to be observed through the open spaces and the strands.
